(19) United States
(12) Patent Application Publication
(10) Pub. No.: US 2002/0147005 A1
(43) Pub. Date: Oct. 10, 2002

(54) Information processing apparatus

(75) Inventors: Fumiyoshi Tezuka, Ome-shi (JP); Takafumi Ito, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/095,706

(22) Filed: Mar. 13, 2002

(30) Foreign Application Priority Data
Mar. 14, 2001 (JP) 2001-072931

(51) Int. Cl. H04M 3/00

(52) U.S. Cl. 455/418; 455/403; 455/73

(57) ABSTRACT

In an information processing apparatus including a radio communication section, a main control section, and a sub-control section, the sub-control section has some functions of radio communication. The sub-control section is, for example, a power supply microcomputer. When an external radio device issues a connection request for radio communication to the radio communication section, the sub-control section performs a process corresponding to the connection request if the process can be performed in accordance with the type or process contents of the device. If the sub-control section cannot perform the process, the main control section starts up and performs the process.

### CROSS-REFERENCE TO RELATED APPLICATIONS

This application is based upon and claims the benefit of priority from the prior Japanese Patent Application No. 2001-072931, filed Mar. 14, 2001, the entire contents of which are incorporated herein by reference.

### BACKGROUND OF THE INVENTION

1. Field of the Invention

The present invention relates to an information processing apparatus such as a personal computer having a radio communication function. More specifically, the present invention relates to an information processing apparatus having a method of starting up a system when a connection request for radio communication is issued from an external radio device.

2. Description of the Related Art

In accordance with recent development in radio communication technology, an opportunity to perform data communication by radio between a personal computer (hereinafter referred to as a PC) having a radio communication function and an external radio device have been increased. For example, Bluetooth, HOME RF are known as a method of radio communication.

In a prior art PC having a radio communication function as described above, when an external radio device issues a connection request for radio communication, a CPU of the PC starts up to perform a process corresponding to the connection request regardless of the type and process contents of the external radio device. The PC therefore has a problem that the CPU always starts up at the time of radio communication and power is consumed each time the CPU starts up.

### BRIEF SUMMARY OF THE INVENTION

An object of the present invention is to provide an information processing apparatus that is capable of controlling a system at the time of radio communication to reduce power consumption.

An information processing apparatus comprising:

a receiver configured to receive a connection request for radio communication from an external radio device;

a sub-control section configured to perform some of processes to communicate with the external radio device when the connection request is received; and

a main control section configured to perform a remaining process which is unexecutable by the sub-control section when the connection request is received.

An information processing apparatus according to a second aspect of the present invention comprises:

a radio communication section which performs radio communication with an external radio device;

a main control section which performs various processes; and

a sub-control section including:

a device determination section which determines whether the external radio device is operable by the sub-control section when the external radio device issues a connection request for radio communication to the radio communication section;

a processing section which performs a process corresponding to the connection request when the device determination section determines that the external radio device is operable by the sub-control section; and

a startup control section which starts up the main control section when the device determination section determines that the external radio device is inoperable by the sub-control section.

An information processing apparatus according to a third aspect of the present invention comprises:

a radio communication section which performs radio communication with an external radio device;

a main control section which performs various processes; and

a sub-control section including:

a device determination section which determines whether the external radio device is operable by the sub-control section or the main control section, when the external radio device issues a connection request for radio communication to the radio communication section;

a processing section which performs a process corresponding to the connection request when the device determination section determines that the external radio device is operable by the sub-control section; and

a startup control section which starts up the main control section when the device determination section determines that the external radio device is operable by the main control section and rejects the connection request when the device determination section determines that the external radio device is inoperable by the sub-control section and the main control section.

An information processing apparatus according to a fourth aspect of the present invention comprises:

a radio communication section which performs radio communication with an external radio device;

a main control section which performs various processes; and

a sub-control section including:

a process content determination section which acquires process contents after a link is established between the process content determination section and the external radio device and determines whether the process contents are processible by the sub-control section, when the external radio device issues a connection request for radio communication to the radio communication section;

a processing section which performs a process corresponding to the process contents when the device determination section determines that the process contents of the external radio device is processible by the sub-control section; and

a startup control section which starts up the main control section when the device determination section determines that the process contents of the external radio device is not processible by the sub-control section.

An information processing apparatus according to a fifth aspect of the present invention comprises:

a radio communication section which performs radio communication with an external radio device;

a main control section which performs various processes; and

a sub-control section including:

a process content determination section which acquires process contents after a link is established between the process content determination section and the external radio device and determines whether the process contents are processible by the sub-control section or the main control section, when the external radio device issues a connection request for radio communication to the radio communication section;

a processing section which performs a process corresponding to the process contents when the device determination section determines that the process contents of the external radio device is processible by the sub-control section; and

a startup control section which starts up the main control section when the device determination section determines that the process contents of the external radio device are processible by not the sub-control section but the main control section and which disconnects the external radio device when the process contents are not processible even by the main control section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of an information processing apparatus according to one embodiment of the present invention.

FIG. 2 is a block diagram showing a configuration of software when the information processing apparatus is constructed by protocol stack of Bluetooth.

FIG. 3 is a flowchart showing an operation of an EC included in the information processing apparatus.

FIGS. 4A and 4B are sequence charts showing a procedure when the EC determines whether to perform a process by the type of equipment.

FIGS. 5A and 5B are sequence charts showing a procedure when the EC determines whether to perform by the contents of a process.

### DETAILED DESCRIPTION OF THE INVENTION

One embodiment of the present invention will now be described with reference to the accompanying drawings.

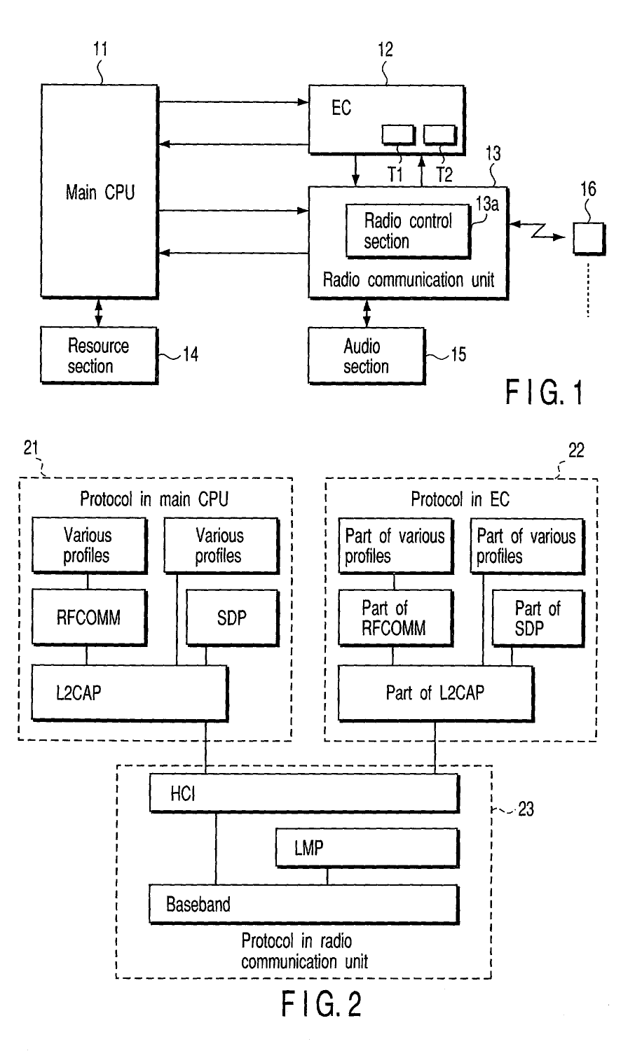

FIG. 1 is a block diagram showing a configuration of an information processing apparatus according to the embodiment of the present invention. The information processing apparatus is constructed by a personal computer which reads programs recorded on a recording medium such as a magnetic disk and whose operation is controlled by the programs.

As illustrated in FIG. 1, the information processing apparatus comprises a main CPU 11, an EC (embedded controller) 12, a radio communication unit 13, a resource section 14, an audio section 15, and a power unit (not shown).

The main CPU 11 controls the whole system and reads programs stored in a memory (not shown) to execute various processes including the control of the resource section 14. The main CPU 11 operates in one of a normal operation mode and a power saving mode. The EC 12 is a microcomputer for controlling a power supply, which starts up the main CPU 11 and runs the system of the apparatus when any event occurs. More specifically, when an event occurs, the EC 12 gives an instruction to the power unit to apply a driving power supply voltage to various circuit sections including the main CPU 11 and change an operation mode of the main CPU 11 from the power saving mode (sleeping state) to the normal operation mode, thereby starting up the main CPU 11 and running the system. The throughput of the EC 12 is lower than that of the main CPU 11 and the power consumption of the EC 12 is lower than that of the main CPU 11.

The radio communication unit 13 is built in the information processing apparatus and includes a radio control section 13a for radio communication between the unit 13 and external radio device 16. For example, Bluetooth (BT) is used as a radio communication system of the radio communication unit 13. Bluetooth is a radio communication system that conforms to the short-range radio communication standard, which carries out radio communication within a range about 10 m using a radio wave of, e.g., a 2.45-GHz ISM (industrial scientific medical) band. The external radio device 16 has a Bluetooth module and is capable of sending and receiving data by radio within a given radio communication range. The external radio device 16 includes electronic devices such as a telephone set and a facsimile machine as well as terminal devices such as a PC. These devices have the same radio communication function (Bluetooth) as that of the information processing apparatus.

The resource section 14 comprises various types of devices, such as a memory, a keyboard, a mouse, a display, an HDD (hard disk drive), and an FDD (floppy disk drive), which are used as resources of the main CPU 11. The audio section 15 supplies and receives voice data and includes a microphone and a speaker.

In the present embodiment, the EC 12 that controls the power supply is employed as a sub-CPU of the main CPU 11. The EC 12 is provided with link control and some of a plurality of profiles (application layers) to perform the minimum process in accordance with the type and process contents of the external radio device 16 that issues a connection request for radio communication. When the capability of the main CPU 11 having the high throughput is required, for example, the resource section 14 is to be controlled, the main CPU 11 is started up.

If the radio communication system is Bluetooth, various profiles such as a dial-up connection profile, a LAN profile, a FAX profile, a headset profile, and a cordless telephone profile are defined therein. Of these profiles, the headset and cordless telephone profiles can be processed without any capability of the main CPU 11, so that the EC 12 having the low throughput is provided with the capability of radio communication for these devices. In other words, the EC 12 performs a process for a connection request issued from a device that processes voice data. More specifically, the EC 12 performs a series of processes such as call incoming control, link control of ACL (asynchronous connection-less link) and SCO (synchronous connection-oriented link), and voice data send/receive control.

The EC 12 can process a part of the FAX profile. This means that when a facsimile machine issues a connection request, the EC 12 performs a process to determine whether a call is received from the facsimile machine. If the EC 12 determines that the call is received from the facsimile machine, the main CPU 11 performs the subsequent processes.

Further, the EC 12 can process part of an HID (human interface device) profile. More specifically, the EC 12 can perform various processes until it receives a request from an HID. When the EC 12 confirms that the HID is a specific one (e.g., keyboard), the main CPU 11 performs the subsequent processes.

FIG. 2 shows a configuration of software when the information processing apparatus is constructed by protocol stack of Bluetooth. In FIG. 2, reference numeral 21 indicates the structure of protocol in the main CPU 11, 22 shows that of protocol in the EC 12, and 23 denotes that of protocol in the radio communication unit 13 (Bluetooth module).

RFCOMM is an emulator of RS-232C (COM port). SDP (service discovery protocol) is protocol for confirming effective service at the present time. L2CAP (logical link control adaptation protocol) is protocol for combining upper and lower layers, splitting them, and assembling them, which corresponds to a section for managing a logical channel.

HCI (host control interface) is protocol for communicating between a host and a host controller. The host is application software using a Bluetooth device, while the host controller is hardware (Bluetooth module).

LMP (link manager protocol) is protocol for establishing a link and controlling security. Baseband is protocol for interfacing data that is actually sent and received.

In order to realize the functions as shown in FIG. 2, the EC 12 of the information processing apparatus includes a startup condition table T1 for the main CPU and a startup condition table T2 for the EC. These tables T1 and T2 are referred to when the external radio device 16 makes a connection request.

The startup condition table T1 stores startup conditions of the main CPU 11. The table T1 stores both identification information of external radio devices which cannot be operated by the EC 12 but can be operated by the main CPU 11 and control information indicative of contents to be processed by the main CPU 11. The startup condition table T2 stores startup conditions of the EC 12. The table T2 stores both identification information of external radio devices which can be operate even by the low throughput EC 12 and control information indicative of contents to be processed by the EC 12.

Specifically, the above identification information is a Bluetooth address (referred to as a BD address hereinafter). In the Bluetooth, an identifier called a 48-bit BD address is given to each Bluetooth device regardless of a master or a slave. The BD address is defined by the address system that conforms to the IEEE802 specifications and uniquely supplied to each Bluetooth device.

Of the devices defined in each profile of the Bluetooth, a device that processes only voice data, such as a telephone set, can be operated by the EC 12. The BD address of the device is set in the startup condition table T2 for the EC 12 and those of the other devices are set in the startup condition table T1 for the main CPU 11.

The contents to be processed by the respective devices include call incoming control, link control, and data send/receive control. Of these, the incoming control and link control can be performed even by the EC 12, and control information indicative of the process contents is set in the startup condition table T2 for the EC. The send/receive control for fax data and the like is performed by the main CPU 11, and control information indicative of the process contents is set in the startup condition table T1 for the main CPU. However, a device that processes only voice data, such as a telephone set, can be operated even by the EC 12; therefore, control information indicative of a series of processes for the voice data is set in the startup condition table T2 for the EC.

An operation of the above-described information processing apparatus will now be described.

First, the main CPU 11 notifies the EC 12 of the startup conditions of the main CPU 11 and EC 12 before the main CPU 11 goes into power saving mode. These startup conditions correspond to both identification information (BD addresses) of devices to be operated by the main CPU 11 or EC 12 and control information indicating the contents to be processed by the main CPU 11 or EC 12. The startup conditions (identification information/control information) of the main CPU 11 are stored in the startup condition table T1, while the startup conditions (identification information/control information) of the EC 12 are stored in the startup condition table T2.

After the startup conditions of the main CPU 11 and EC 12 are stored in the respective startup condition tables T1 and T2, the main CPU 11 goes into power saving mode and then the following process is performed under the control of the EC 12 serving as a power supply microcomputer.

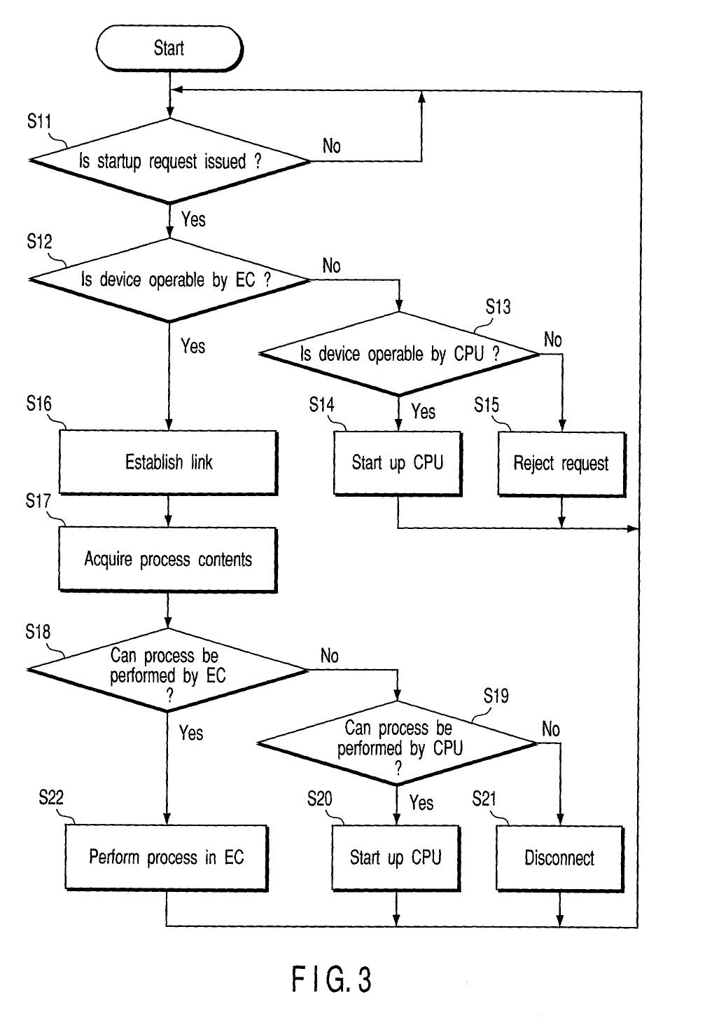

FIG. 3 is a flowchart showing an operation of the EC 12 of the information processing apparatus of the present invention.

When the external radio device 16, which is located around the information processing apparatus (PC), issues a connection request for radio communication to the radio communication unit 13, the unit 13 outputs a request to start up the apparatus (PC). Then, the startup request is temporarily supplied to the EC 12.

When the EC 12 receives a startup request from the radio communication unit 13 (Yes in step S11), it determines whether the external radio device 16 that issued the connection request is to be operated by the EC 12 (step S12). This determination is performed by checking whether the identification information which has been given to the external radio device 16 is set in the startup condition table T2 for the EC. If the identification information of the external radio device 16 is set in the startup condition table T2 and the device 16 is determined to be operated by the EC 12 (Yes in step S12), the EC 12 establishes a link between the EC 12 and external radio device 16 according to given procedures and makes a connection between them by radio (step S16).

On the other hand, if the identification information of the external radio device 16 is not set in the startup condition table T2 for the EC and the device 16 is not determined to be operated by the EC 12 (No in step S12), then the EC 12 determines whether the device 16 is to be operated by the main CPU 11 (step S13). This determination is performed by checking whether the identification information given to the external radio device 16 that issued the connection request is set in the startup condition table T1 for the main CPU. If the identification information of the external radio device 16 is set in the startup condition table T1 and the device 16 is determined to be operated by the main CPU 11 (Yes in step S13), then the EC 12 issues a startup request to the main CPU 11 and changes the operation mode of the main CPU 11 from the power saving mode to the normal operation mode (step S14). After that, a series of processes including the link control is executed under the control of the main CPU 11.

If the external radio device 16 is an unknown device that cannot be operated by the main CPU 11 (No in step S13), the EC 12 rejects the connection request (step S15).

When a link is established between the EC 12 and the external radio device 16 in step S16 as described above, the EC 12 acquires the process contents (contents of service) of the external radio device 16 (step S17). The process contents can be specified according to the type of the device that issued a connection request. If the external radio device 16 is a telephone set, the EC 12 can determine that voice data is sent and received.

Then, the EC 12 determines whether a process corresponding to the above process contents can be performed by the EC 12 or not (step S18). This determination is performed by checking whether control information indicative of the process contents is set in the startup condition table T2 for the EC. If the control information is set in the table T2 and the process is determined to be performed by the EC 12 (Yes in step S18), then the EC 12 does not start up the main CPU 11 but performs the process corresponding to the process contents (step S22).

If the control information indicative of the process contents is not set in the startup condition table T2 and the process is determined not to be performed by the EC 12 (No in step S18), then the EC 12 determines whether the process is to be performed by the main CPU 11 (step S19). This determination is performed by checking whether the control information indicative of the process contents is set in the startup condition table T1 for the main CPU. If the control information is set in the table T1 and the process is determined to be performed by the main CPU 11 (Yes in step S19), the EC 12 issues a startup request to the main CPU 11 and change the operation mode of the main CPU 11 from the power saving mode to the normal operation mode (step S20). After that, the process corresponding to the process contents is performed under the control of the main CPU 11.

When the process for the external radio device 16 is not defined or cannot be performed by the main CPU 11 (No in step S19), the EC 12 is disconnected from the external radio device 16 (step S21).

As described above, the EC 12 starts up the main CPU 11 in accordance with the type of the external radio device that issued a connection request or process contents included in the request. When the EC 12 can process the contents, it performs a process of radio communication with the external radio device 16 through the radio communication unit 13 without starting up the main CPU 11.

The above-described radio communication will now be described by specific examples.

Assume a telephone set, a facsimile machine, and a telephone/facsimile machine as the external radio device 16. The telephone set has a function of sending/receiving voice data. The facsimile machine has a function of sending/receiving fax data. The telephone/facsimile machine has a function of sending/receiving both voice data and fax data. These are BT-capable devices and have a radio communication function.

When a device as described above issues a connection request for radio communication, the EC 12 determines whether to perform a process based on the following two cases:

(1) The EC 12 determines whether to perform the process by the type of the device:

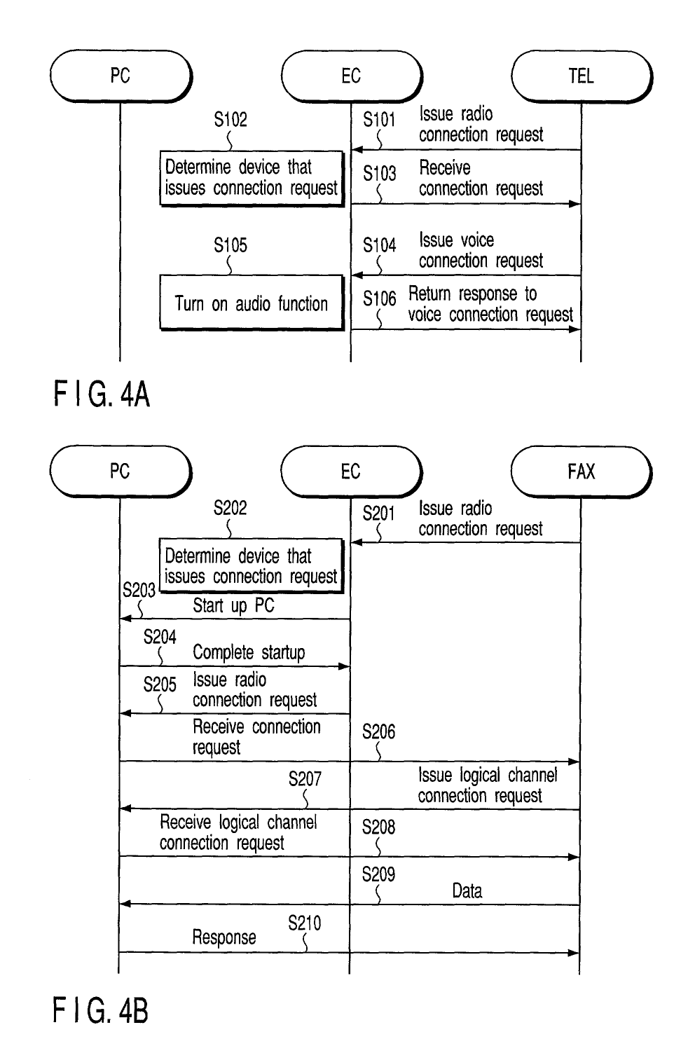

FIGS. 4A and 4B are sequence charts each showing

a procedure executed when the EC 12 determines

a process by the type of a device that makes

a connection request. FIG. 4A shows a procedure executed when the device is a telephone set and FIG. 4B shows a procedure executed when the device is a facsimile machine. In these figures, PC indicates the main CPU 11 of the information processing apparatus and TEL represents a telephone set.

When the telephone set issues a connection request for radio communication to the radio communication unit 13 as shown in FIG. 4A, a startup request is made to the EC 12 (step S101). The EC 12 determines the type of the device that issued the connection request (step S102). If the EC 12 determines that it can operate the device, it receives the connection request from the device and establishes a link between them (step S103).

When the telephone set issues a connection request for voice data (step S104), the EC 12 starts up the audio section 15 (step S105) and then returns a response to the connection request (step S106). After that, the voice data is transferred between the apparatus and the telephone set under the control of the EC 12.

If the device that issues the connection request is a telephone set as described above, a series of processes including link control is performed under the control of the EC 12, and the main CPU 11 is not started up. In contrast, if the device is a facsimile machine, the following procedure is executed.

When the facsimile machine issues a connection request for radio communication to the radio communication unit 13 as shown in FIG. 4B, a startup request is made to the EC 12 (step S201). The EC 12 determines the type of the device that issued the connection request. If the EC 12 determines that the device cannot be operated by the EC 12 but by the main CPU 11, it gives a startup instruction to the main CPU 11 (step S203). Thus, the main CPU 11 returns from the power saving mode to the normal operation mode to start up the system of the apparatus. The main CPU 11 then notifies the EC 12 that the startup is completed.

When the EC 12 confirms the notification that the startup of the main CPU 11 is completed (step S204), it informs the main CPU 11 that the facsimile machine issued the connection request (step S205). After that, a link between the apparatus and the facsimile machine is established under the control of the main CPU 11 and then fax data is transmitted and received (steps S206 to S210).

If the device that issues the connection request is a facsimile machine as described above, the EC 12 receives the connection request and the main CPU 11 is started up. Then, a series of processes is performed under the control of the main CPU 11.

(2) The EC 12 determines whether to perform the process by the contents to be processed by the device (contents of service):

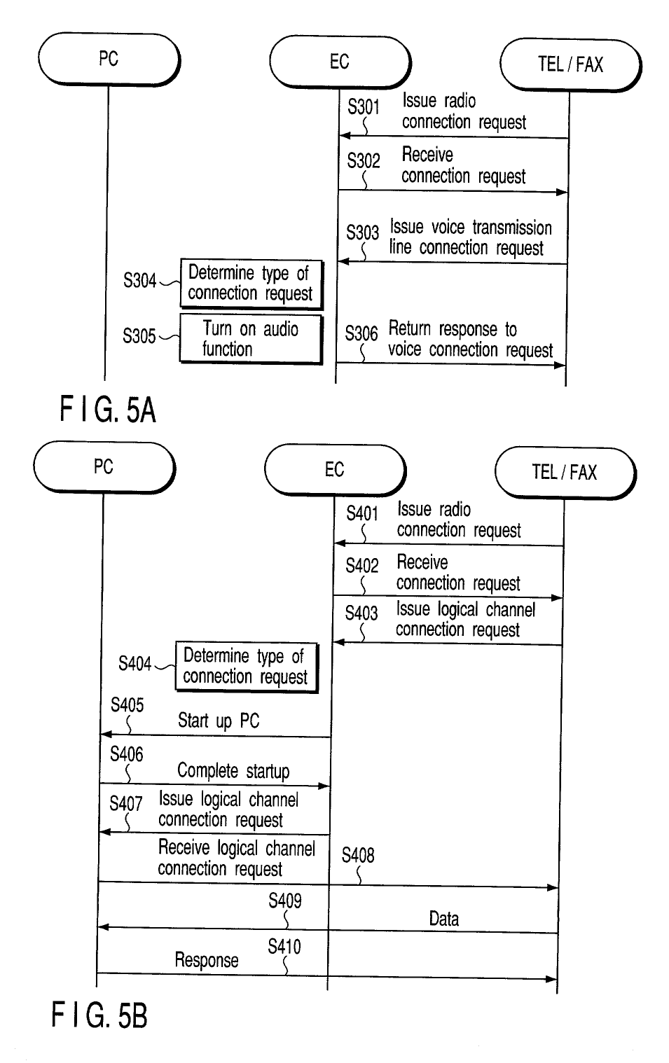

FIGS. 5A and 5B are sequence charts each showing a procedure executed when the EC 12 determines a process by the process contents. FIG. SA shows a procedure of voice communication and FIG. 5B shows a procedure of facsimile reception. In these figures, PC indicates the main CPU 11 of the information processing apparatus and TEL/FAX represents a telephone/facsimile machine.

When the telephone/facsimile machine issues a connection request for radio communication to the radio communication unit 13 as shown in FIG. 5A, a startup request is made to the EC 12 (step S301). The EC 12 receives the connection request from the machine and establishes a link between them (step S302).

When the telephone/facsimile machine issues a voice transmission line connection request (step S303), the EC 12 determines the contents of the connection request (step S304). The contents of the connection request correspond to connection of voice transmission lines or transmission/reception of voice data, and are set as ones to be processed by the EC 12. Therefore, the EC 12 starts up the audio section 15 (step S305) and then returns a response to the connection request for the voice data (step S306).

After that, voice data is transferred between the apparatus and the telephone/facsimile machine under the control of the EC 12.

If the contents of a process required by the device that issues the connection request are voice communication as described above, a series of processes including link control is performed under the control of the EC 12, and the main CPU 11 is not started up.

In contrast, if the process contents required by the device are reception of facsimile data, the following procedure is executed.

When the telephone/facsimile machine issues a connection request for radio communication to the radio communication unit 13 as shown in FIG. 5B, a startup request is made to the EC 12 (step S401). The EC 12 receives the connection request from the machine and establishes a link between them (step S402).

When the telephone/facsimile machine issues a logical channel connection request (step S403), the EC 12 determines the contents of the connection request (step S404). The contents of the connection request correspond to connection of logical channels or reception of facsimile data, and are set as ones to be processed in advance by the main CPU 11. Therefore, the EC 12 gives a startup instruction to the main CPU 11 (step S405). Thus, the main CPU 11 is returned from the power saving mode to the normal operation mode to start up the system of the apparatus.

When the EC 12 confirms the notification that the startup of the main CPU 11 is completed (step S406), it informs the main CPU 11 that the telephone/facsimile machine issued the logical channel connection request (step S407). After that, a logical channel between the apparatus and the telephone/facsimile machine is established under the control of the main CPU 11 and then fax data is transmitted and received (steps S408 to S410).

If the process contents required by the device that issues the connection request correspond to the reception of facsimile data as described above, the EC 12 receives the connection request and the main CPU 11 is started up. Then, a series of processes is performed under the control of the main CPU 11.

As described above, since the EC 12 (power supply microcomputer) has some functions of radio communication, the main CPU 11 can be prevented from always starting up at the time of radio communication and thus power consumption can be decreased. If, therefore, the information processing apparatus of the present invention is a portable PC that is driven using a battery as a power supply, the consumption of the battery due to radio communication can be decreased, and the life of the battery can be lengthened.

The present invention is not limited to a PC but applicable to all of information processing apparatuses having a radio communication function such as a PDA (personal digital assistants). The same advantages as those described above can thus be obtained.

As the radio communication function, not only Bluetooth but also the other communication systems such as HOME RF can be used.

The sub-CPU is not limited to the EC 12. For example, a new controller whose throughput is low and power consumption is not high, can be provided and caused to have some functions of radio communication. To provide a new controller however increases a component count and costs. It is thus desirable to use the EC 12 that is a standard device as a power supply microcomputer (a controller for controlling a power supply) as in the foregoing embodiment of the present invention.

In the technique according to the foregoing embodiment of the present invention, programs that can be executed by a computer can be written to a recording medium such as a magnetic disk (flexible disk, hard disk, etc.), an optical disk (CD-ROM, DVD, etc.), and a semiconductor memory and applied to various devices, or these programs can be transmitted through a transmission medium such as a network and applied to various devices. The computer that is constructed by the information processing apparatus of the present invention reads programs recorded on a recording medium or programs provided through a transmission medium, and its operation is controlled by the programs, thereby performing the process described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a receiver configured to receive a connection request for radio communication from an external radio device;
a sub-control section configured to perform some of processes to communicate with the external radio device when the connection request is received; and
a main control section configured to perform a remaining process which is unexecutable by the sub-control section when the connection request is received.

2. The information processing apparatus according to claim 1, wherein the sub-control section starts up the main control section when the connection request issued from the external radio device includes control of resources.

3. The information processing apparatus according to claim 1, wherein the sub-control section includes a controller which controls a power supply of a whole system including the main control section.

4. An information processing apparatus comprising:
a radio communication section which performs radio communication with an external radio device;
a main control section which performs various processes; and
a sub-control section including:
a device determination section which determines whether the external radio device is operable by the sub-control section when the external radio device issues a connection request for radio communication to the radio communication section;
a processing section which performs a process corresponding to the connection request when the device determination section determines that the external radio device is operable by the sub-control section; and
a startup control section which starts up the main control section when the device determination section determines that the external radio device is inoperable by the sub-control section.

5. The information processing apparatus according to claim 4, further comprising a table which stores identification information of devices to be operated by the sub-control section,
wherein the device determination section compares identification information of the external radio device with the identification information of the devices stored in the table and determines whether the external radio device is operable by the sub-control section.

6. The information processing apparatus according to claim 4, wherein the sub-control section includes a controller which controls a power supply of a whole system including the main control section.

7. An information processing apparatus comprising:
a radio communication section which performs radio communication with an external radio device;
a main control section which performs various processes; and
a sub-control section including:
a device determination section which determines whether the external radio device is operable by the sub-control section or the main control section, when the external radio device issues a connection request for radio communication to the radio communication section;
a processing section which performs a process corresponding to the connection request when the device determination section determines that the external radio device is operable by the sub-control section; and
a startup control section which starts up the main control section when the device determination section determines that the external radio device is operable by the main control section and rejects the connection request when the device determination section determines that the external radio device is inoperable by the sub-control section and the main control section.

8. The information processing apparatus according to claim 7, further comprising a table which stores identification information of devices to be operated by the sub-control section and identification information of devices to be operated by the main control section,
wherein the device determination section compares identification information of the external radio device with the identification information of the devices stored in the table and determines whether the external radio device is operable by the sub-control section or the main control section.

9. The information processing apparatus according to claim 7, wherein the sub-control section includes a controller which controls a power supply of a whole system including the main control section.

10. An information processing apparatus comprising:
a radio communication section which performs radio communication with an external radio device;
a main control section which performs various processes; and
a sub-control section including:
a process content determination section which acquires process contents after a link is established between the process content determination section and
the external radio device and determines whether the process contents are processible by the sub-control section, when the external radio device issues a connection request for radio communication to the radio communication section;
a processing section which performs a process corresponding to the process contents when the device determination section determines that the process contents of the external radio device is processible by the sub-control section; and
a startup control section which starts up the main control section when the device determination section determines that the process contents of the external radio device is not processible by the sub-control section.

11. The information processing apparatus according to claim 10, further comprising a table which stores control information indicative of predetermined process contents which are executed by the sub-control section for each external device,
wherein the process content determination section determines that the process contents of the external radio device are processible by the sub-control section when the process contents correspond to those indicated by the control information stored in the table.

12. The information processing apparatus according to claim 10, wherein the sub-control section includes a controller which controls a power supply of a whole system including the main control section.

13. An information processing apparatus comprising:
a radio communication section which performs radio communication with an external radio device;
a main control section which performs various processes; and
a sub-control section including:
a process content determination section which acquires process contents after a link is established between the process content determination section and the external radio device and determines whether the process contents are processible by the sub-control section or the main control section, when the external radio device issues a connection request for radio communication to the radio communication section;
a processing section which performs a process corresponding to the process contents when the device determination section determines that the process contents of the external radio device is processible by the sub-control section; and
a startup control section which starts up the main control section when the device determination section determines that the process contents of the external radio device are processible by not the sub-control section but the main control section and which disconnects the external radio device when the process contents are not processible even by the main control section.

14. The information processing apparatus according to claim 13, further comprising a table which stores control information indicative of predetermined process contents which are executed by the sub-control section and the main control section for each external device, wherein the process content determination section compares the process contents of the external radio device and the control information stored in the table and determines whether the process contents of the external radio device are processible by the sub-control section or the main control section.

15. The information processing apparatus according to claim 13, wherein the sub-control section includes a controller which controls a power supply of a whole system including the main control section.
